(19) United States
(12) Patent Application Publication
(10) Pub. No.: US 2009/0063437 A1
(43) Pub. Date: Mar. 5, 2009

(54) Secure hosted databases

(76) Inventors: Geoffrey R. Hendrey, (US); Brent E. Hamby, (US)

Correspondence Address: FENWICK & WEST LLP, SILICON VALLEY CENTER, 801 CALIFORNIA STREET, MOUNTAIN VIEW, CA, 94041, US

(21) Appl. No.: 12/157,721

(22) Filed: Jun. 11, 2008

Related U.S. Application Data
(60) Provisional application No. 60/934,073, filed on Jun. 11, 2007.

(51) Int. Cl. G06F 17/30

(52) U.S. Cl. 707/4; 707/E17.141

(57) ABSTRACT

A hosted relational database can be securely accessed by application developers, relieving the developer of the need to engage in server side development. A database programming API is accessible from a browser-based application that abstracts details of client/server HTTP communication with the database. This results in a reduction in software development because the developer's application does not require server-side programming or database installation and administration. There is a consummate reduction in hardware costs for the application developer, since those costs are borne by the hosted database provider. One or more physical database systems are segmented into virtual databases. The owner of a virtual database configures the data model through a web-based user interface. Parameterized queries and relationships between tables are also created using the web-based interface.

### CROSS-REFERENCE TO RELATED APPLICATION

This application claims the benefit of U.S. Provisional Application No. 60/934,073, filed on Jun. 11, 2007, and incorporated by reference herein in its entirety.

### BACKGROUND OF THE INVENTION

1. Field of the Invention

The present invention relates generally to databases. In particular, the present invention is directed toward providing access to a hosted database via the Internet.

2. Description of Background Art

Conventional databases typically provide access control at the table level. That is, access to modify every row of a table as a whole can be granted or denied to a particular entity such as a software application accessing the database. Row-level access-control, which would specify which end users—such as users of the software application that is accessing the database—could read or write particular rows of a table, is not generally provided. For that reason, direct database access is restricted to trusted applications. In the context of the Internet, row-level access control is implemented by a server-side application that acts as a “gatekeeper” to buffer the database against access by un-trusted clients. Typically, the gatekeeper application authenticates the end-user's login and password by matching against a row stored in the database. Once the user's credentials have been authenticated, a session is established between the server-side application and the end-user's browser, often using HTTP cookies. This is an access control model in which state is maintained, such that once a user has logged into an application, the “logged in” state is established, and the server-side application will issue queries, updates, and deletes to the database without having to re-authenticate the end-user. By employing such an application, the database is protected against harmful manipulation.

To make a database-enabled web application available to an end user over the Internet, an application developer typically writes an application that has components in several tiers: a client HTML and JavaScript component that is executed on a client browser, such as a Microsoft Internet Explorer or Mozilla Firefox; a server-side component to provide authentication of application end-users and manage end-user sessions, typically implemented with HTTP cookies and session objects; a server-side data-access component that either directly executes database queries from within the application logic, or wraps database queries in data access objects (DAOs) that abstract the particulars of database access; and presentation formatting components that generate HTML from data returned by the database.

To assist in some or all of these tasks, server-side applications frequently make use of services provided by HTTP servers or application servers, and the server-side application itself may run as an isolated module inside the HTTP server.

The emerging field of “mashups” deals with applications that retrieve and combine data from multiple web services, often emphasizing client-side application logic. Mashup applications would benefit dramatically from a hosted “mashable” database that would provide secure read and write access to application data without compromising the mashup paradigm.

### SUMMARY OF THE INVENTION

The present invention provides a hosted relational database that can be securely accessed by application developers, relieving the developer of the need to engage in server side development. The present invention includes a security model and a database programming API that is accessible from a browser-based application that abstracts details of client/server HTTP communication with the database. This results in a reduction in software development because the developer's application does not require server-side programming or database installation and administration. There is a consummate reduction in hardware costs for the application developer, since those costs are borne by the hosted database provider.

The present invention allows one or more physical database systems to be segmented into virtual databases. The owner of a virtual database configures the data model through a web-based user interface. Parameterized queries and relationships between tables are also created using the web-based interface.

### BRIEF DESCRIPTION OF THE DRAWINGS

FIG. 1 is a block diagram of a system for providing a secure hosted database in accordance with an embodiment of the present invention.

FIG. 2 illustrates a blogging application using a secure hosted database in accordance with an embodiment of the present invention.

FIG. 3 illustrates a database configuration page for creating a virtual database in accordance with an embodiment of the present invention.

FIG. 4 illustrates a database configuration page for managing a virtual database in accordance with an embodiment of the present invention.

FIG. 5 illustrates a table configuration page in accordance with an embodiment of the present invention.

FIG. 6 illustrates a relationships interface page in accordance with an embodiment of the present invention.

FIG. 7 illustrates a query management page in accordance with an embodiment of the present invention.

FIG. 8 and FIG. 14 illustrate performance monitoring interfaces in accordance with an embodiment of the present invention.

FIG. 9 illustrates a series of database queries and responses in accordance with an embodiment of the present invention.

FIG. 10 illustrates a query result set in accordance with an embodiment of the present invention.

FIG. 11 illustrates a query result set in accordance with an embodiment of the present invention.

FIG. 12 illustrates a column access tree (CAT) in accordance with an embodiment of the present invention.

FIG. 13 illustrates database content of two consecutive pages in accordance with an embodiment of the present invention.

### DETAILED DESCRIPTION OF THE PREFERRED EMBODIMENT

A system of the present invention provides database security using context-sensitive result sets. A security paradigm implemented by system 100 can be described as follows:

Queries are self-authenticating. That is, to provide authenticated access to a particular row or rows, the authentication credentials must be included as parameters each time a query is invoked. The hosted database system maintains no authenticated state for application end-users. Queries and parameter definitions are precompiled and stored by a query building module, and cannot be altered except by the application developer. Ad-hoc queries are not permitted. Note that we presume throughout this description that the application developer is the account holder on system 100. This is merely for clarity of description. Various business relationships, including partnership and outsourcing may lead to the account holder and application developer being, in fact, different entities.

You cannot change what you cannot read. Query results are returned as rows. The native primary key of each row is replaced with a secure unique result identifier called a SURID. To update or delete a row, the end user's client software must pass the SURID back to either the update or delete services of the HTTP server. This prevents update-by-query or delete-by-query which could be used by an application to change or delete portions of the database en masse.

If you can read it, you might be allowed to change it. The SURID is associated with the update and delete permissions of the query that retrieved the row R. This allows a first query to return a read-only view of a particular row, while a second query returns a view of the same row, but that can be updated and/or deleted. The result set is therefore context-sensitive, in that the change permissions for a particular row depend not on the row itself, but on the query that retrieved the row. Because a query may include mandatory parameters that can both authenticate a user and locate one or more rows, by induction a query can be configured so that read, update and delete permissions at a row-level can be made dependent on the identity of the end-user.

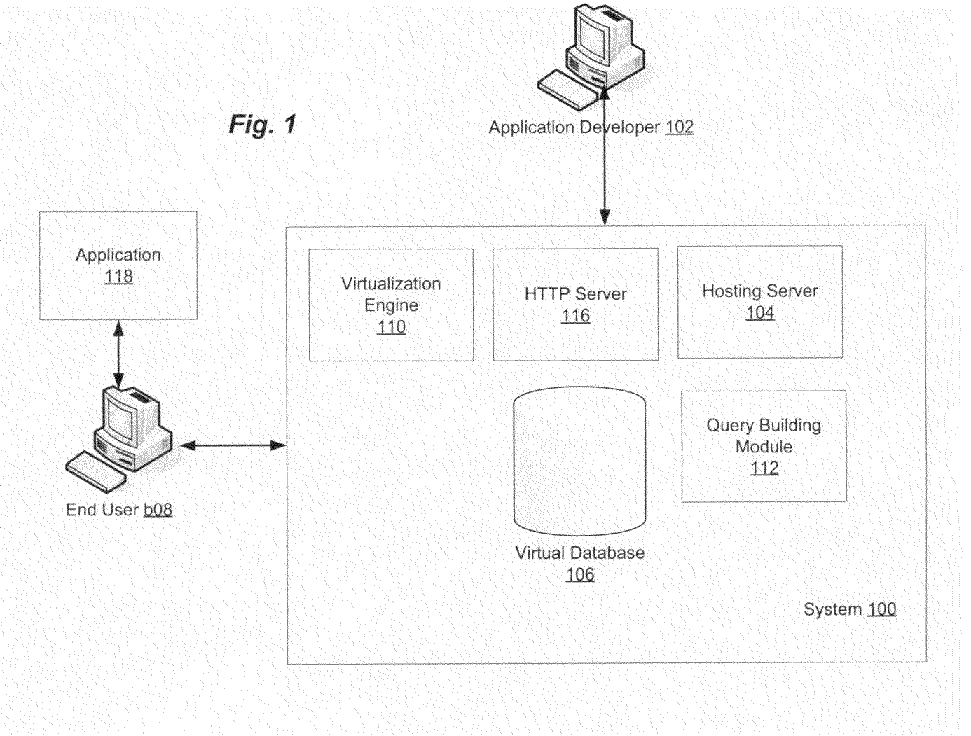

FIG. 1 illustrates a system for providing secure hosted databases. System 100 includes a hosting server 104, virtual database 106, virtualization engine 110, query building module 112, and HTTP server 116. Also shown in FIG. 1 is an application developer 102, and end user 108. End user 108 is also shown to include an application 118.

HTTP server 116 provides an interface between system 100 and end users 108, and between system 100 and application developers 102. HTTP server 116 may be a conventional HTTP server application such as the Apache Tomcat Server from the Apache Software Foundation, or Microsoft Internet Information Server, available from Microsoft Corporation, and may be modified to provide the various functions describe here.

Virtualization engine 110 enables the creation and modification of virtual databases within system 100. Virtual database 106 is a logical database that is associated with an application developer 102. Note that although only one virtual database 106 is included in FIG. 1, this is for clarity of illustration—in practice, system 100 supports tens, hundreds, or more virtual databases 106.

Query building module 112 enables automatic generation of queries using input received from application developer 102 during configuration and administration of virtual database 106.

Hosting server 104 implements access to and management of hosted databases as described further below.

End user 108 is a user of the application 118 developed by application developer 102. Typically, end user 108 uses a client browser such as Microsoft Internet Explorer or Mozilla Firefox to access the World Wide Web, including HTTP server 116. Application 118, provided by application developer 102, is typically executed by the end user's browser. For example, application 118 may be an application written in JavaScript and executing inside the browser. Although only one end user 108 is illustrated for clarity, system 100 supports interaction with multiple users simultaneously.

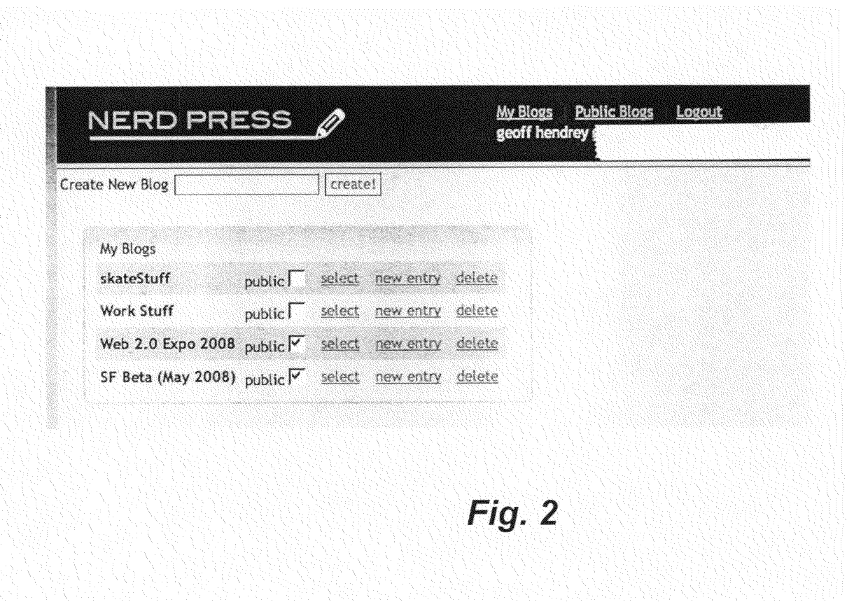

An application developer 102 for purposes of this description is an entity wanting to provide a web-based application to end users 108. One example of a web-based application is a blog hosting site. Continuing the example, end users 108 are blog authors and blog readers. Application developer 102 provides the end-user-facing web interfaces to end users 108 by designing custom web pages in a conventional manner, except as outlined below. FIG. 2 illustrates an example blogging application to which we refer again later in this description.

Initially, application developer 102 establishes an account with the hosting server 104 in order to obtain access to a virtual hosted database. An account may be established between application developer 102 and the operator of system 100 in a variety of ways and using a variety of business models. For example, application developer 102 may pay a daily, weekly, monthly or annual fee for the virtual database, and the fee may depend on the size of the database, the amount of database access over a period of time, etc. Alternatively, a flat fee may be charged, or other models might be used.

Once application developer 102 has an account with system 100, he is able to log in to the hosting server 104 in order to set up and configure his virtual database 106. Note that virtual database 106 may represent any of a number of different physical implementations. For example, a virtual database may be located on a portion of a single physical drive, or may use all of the physical drive, or may use some or all portions of multiple drives on multiple servers. An account in one embodiment includes a login and password, which serve as credentials for the developer 102 to access the hosting server 104, e.g., in order to perform setup and administrative functions.

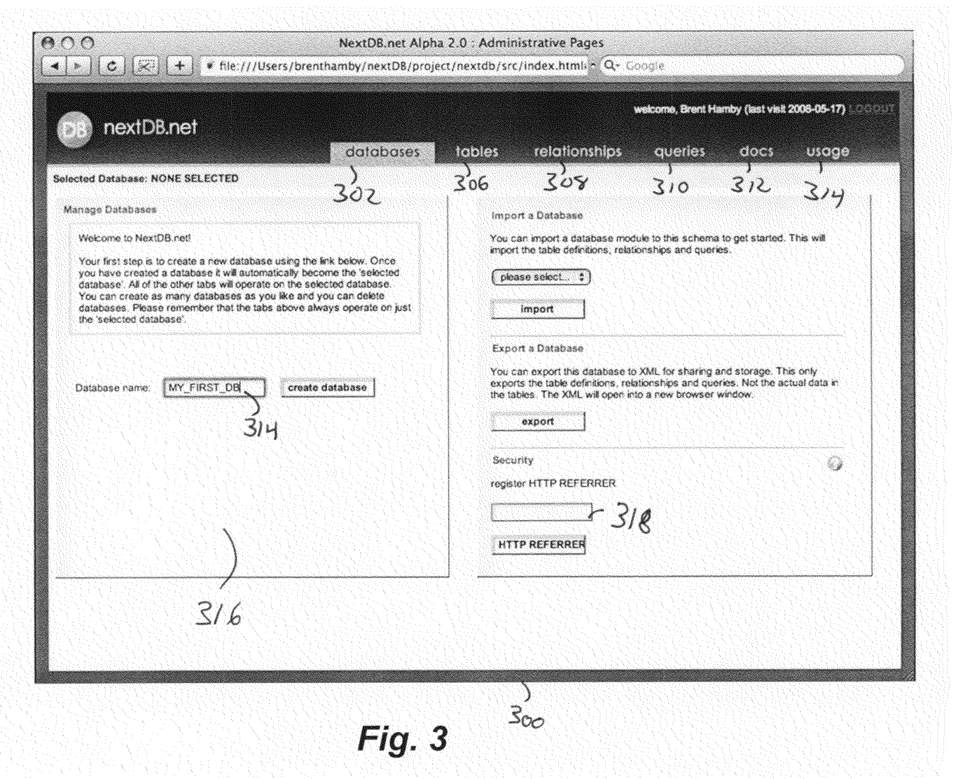

Referring to FIG. 3, once the account holder has been authenticated, hosting server 104 presents a database configuration page 300. In the illustrated example of FIG. 3, database configuration page 300 includes a number of tabs that can be used to perform various administrative functions. Tabs include databases 302, tables 304, relationships 306, queries 308, docs 310 and usage 312 tabs. In one embodiment, the database configuration page 300 is the page displayed first, although in alternative embodiments, other tabs may be displayed first. Docs tab 310 displays documentation such as a user's guide or developer's guide to be displayed. Each of the remaining tabs is described further below.

When an application developer 102 first activates his account, no database is associated with the account. Database configuration page 300 provides a region 316 in which the application developer can create a new database, in one embodiment by typing a database name in a text box 314 and selecting a “create database” option, or similar button. In one embodiment, this action triggers the JavaScript in the application developer's client to access a remote procedure call via a URL to hosting server 104. In one embodiment, the URL is accessed as the src attribute of a <script tag>, using a technique known in the art as a “dynamic script tags”, or JSONP. This action triggers the JavaScript in the application developer's client to invoke an RPC URL on hosting server 104. In one embodiment, the URL is of the following form: http://nextdb.net/nextdb/service/accountName/CREATE_SCHEMA; jsessionID=t9nqz9nkksra?callback=net.nextdb.Request.general Callback&schemaName=MY_FIRST_DB&id=17

Hosting server 104 receives the request and validates the jsession identifier to uniquely identify the session. Virtualization engine 110 then creates a new virtual database 106, and associates it with the application developer's account. The JSON response from the server has the following format:

```
net.nextdb.Request.generalCallback(
  {
  “id”:“17”,
  “message”:“schema created: ‘MY_FIRST_DB’ ”
  }
)
```

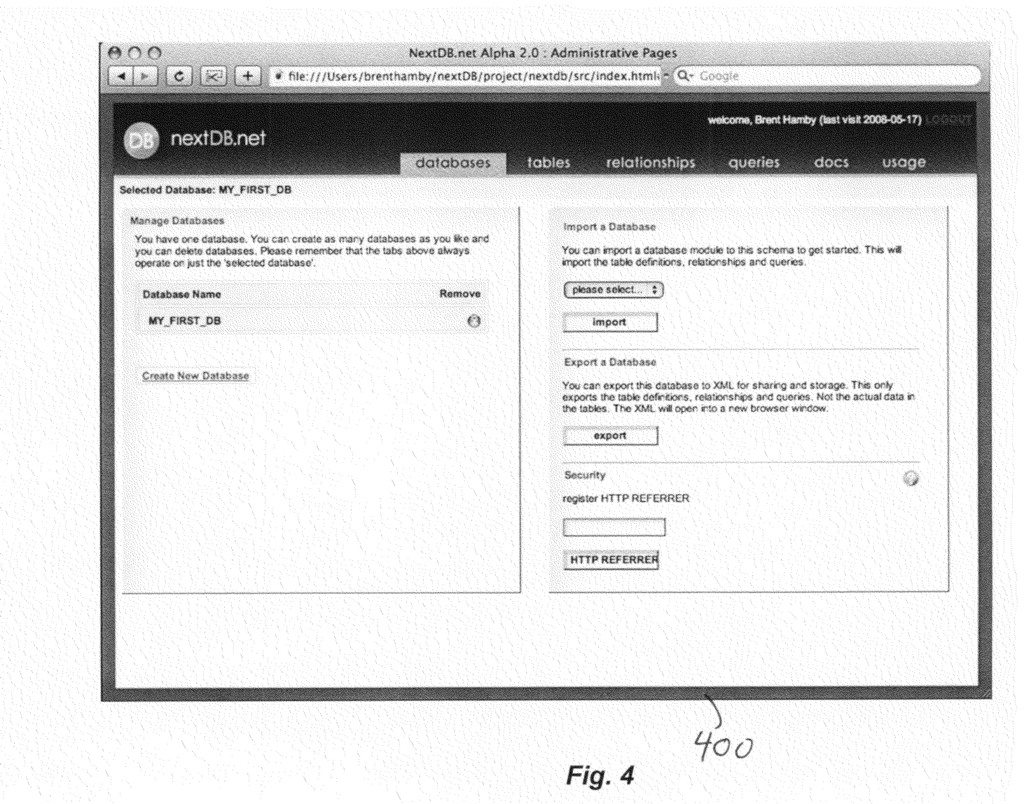

If the database creation is successful, region 316 is updated to reflect the existence of the new database. FIG. 4 illustrates a database configuration page 400 that has been updated in such a manner.

Referring again to FIG. 3, in addition to allowing creation of a new database, database configuration page 300 provides an opportunity for the application developer 102 to import an existing data model from an XML description (table definitions, relationship definitions, and query definitions), or to export an existing data model to XML for sharing or storage.

In addition, an HTTP REFERRER field 318 is provided. This field allows the application developer to specify a list of URLs for web pages that are allowed to send requests to virtual database 106. This provides an extra level of security.

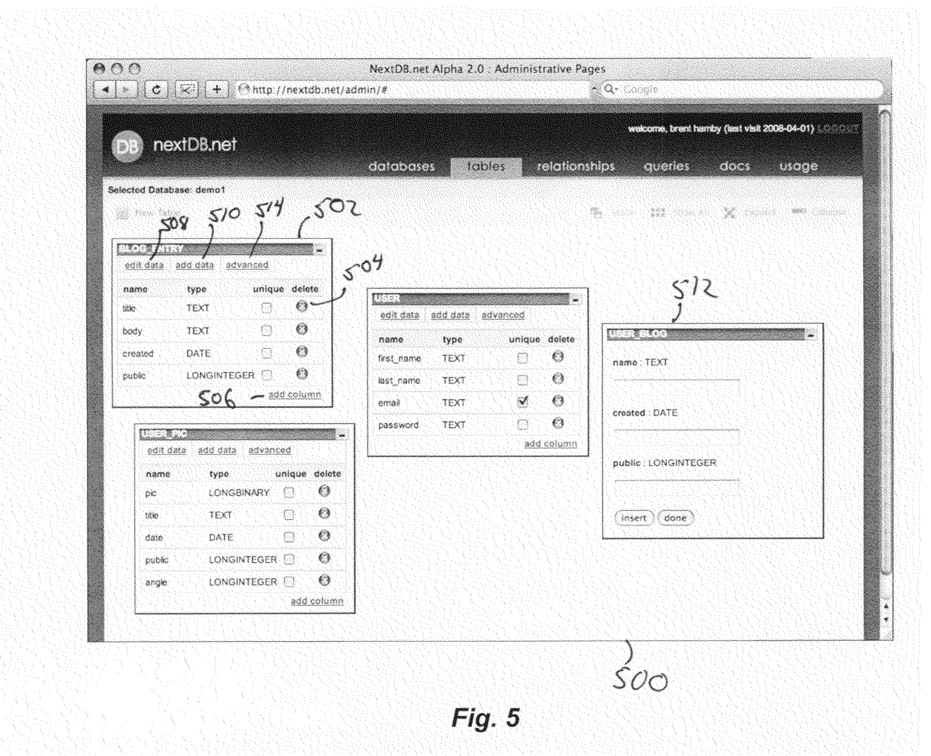

FIG. 5 illustrates a table configuration page 500 of hosting server 104. Table configuration page 500 allows the application developer 102 to add, delete and edit tables for a virtual database 106. For each table, application developer 102 can specify a column's name and type, and whether its values must be unique. For example, table 502 is named BLOG_ENTRY, and has column names “title”, “created”, “body”, and “public”. The title and body columns are of type TEXT, the “created” column is of type “DATE”, and the “public” column is of type “LONGINTEGER”. By clicking a “delete” button 504, a column can be removed from the table, and by clicking an “add column” link 506, a new column can be specified. The “edit data” link 508 and “add data” link 510 allow the developer to edit or add table data, respectively. USER_BLOG table 512 is an example of a table in “add data” mode. Finally, an “advanced” link 514 provides additional table editing ability, including deleting the entire table, and specifying whether CAPTCHA protection should apply to the table. The use of CAPTCHA to protect tables is described in more detail below.

In one embodiment, valid data types include the following:

TEXT—For small, searchable, volumes of characters, like a name, an address, or a product description;

LONGTEXT—For large bodies of text, like a blog post;

DATE—For day-month-year and time of day;

LONGBINARY—For any binary datatype, like a JPG, or a PDF file;

INTEGER—For whole numbers, like 234, or −333; and

DOUBLE—For decimal numbers, like 37.123.

Those of skill in the art will appreciate that more or fewer valid data types may be specified in other embodiments.

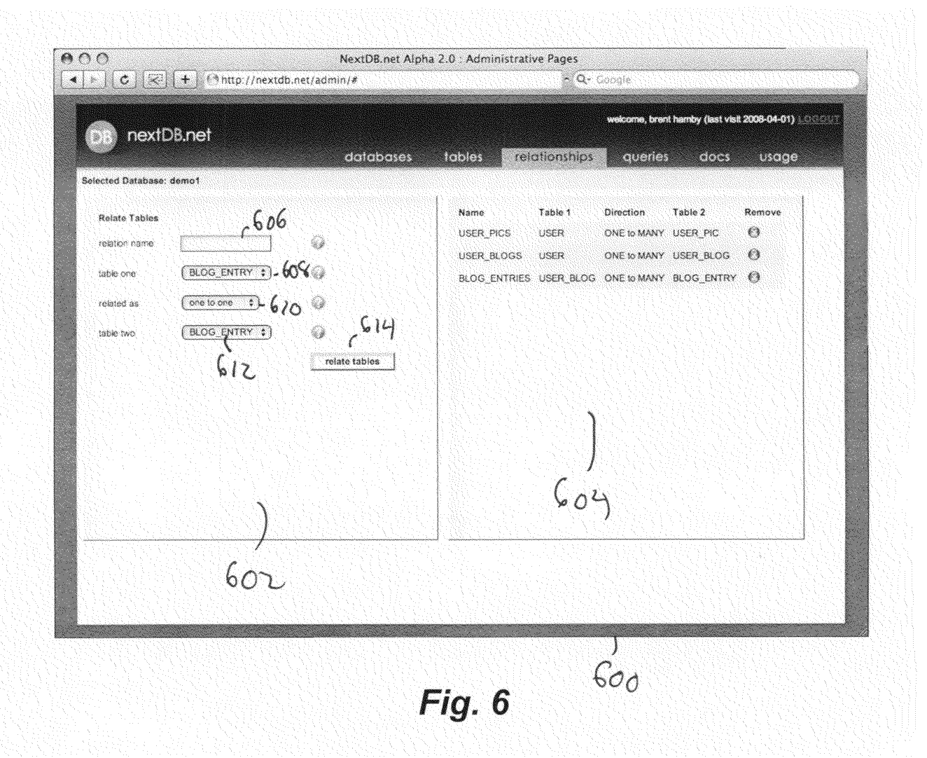

Once application developer 102 has created a set of tables, relationships between those tables can be defined. Referring to FIG. 6, a relationships interface page 600 provides such ability. In one region 602 of page 600, relationships may be specified between two tables. In region 604, the relationships already defined are listed. For example, in the illustrated case, the first listed relationship indicates that the USER table is related to the USER_PIC table. The relationship is given a name, in this case USER_PICS, and the direction of the relationship is ONE to MANY. That is, the USER_PICS relationship specifies that a single row of the USER table may be related to multiple rows of the USER_PIC table. In the blog example, this suggests that a single user of the blogging web site may be allowed to upload multiple pictures to the site. Similarly, the USER_BLOGS relationships indicates that a row of the USER table may be related to many rows in the USER_BLOG table; and the BLOG_ENTRIES relationship dictates that a row in the USER_BLOG table is related to many BLOG_ENTRY rows. Each of the indicated relationships may be removed by clicking an appropriate icon such as an “x” in the “Remove” column.

Region 602 illustrates fields for defining a relationship between tables. The relationship name is specified in the “relationship name” field 606; the first table is chosen from a list of table names defined for virtual database 106 and listed in drop down box 608; a relationship type is selected from drop down box 610; and the name of the second table is chosen from drop down box 612. Selection of the “relate tables” button 614 establishes the relationship. In one embodiment, a relationship's cardinality may be one-to-one or one-to-many. Those of skill in the art will appreciate that additional relationships may additionally be implemented.

By treating relationships in this way, system 100 obviates the need for application developer 102 to manage foreign keys, as would be necessary in a conventional application. Internally, system 100 establishes the required foreign key definitions, and uses the foreign keys to perform joins ans required by the RELATED operator. Application developer 102 is never exposed to foreign keys.

After a relationship between tables has been defined, the relationship can be accessed at runtime in order to link rows in related tables. The following service URL shows how two existing rows are linked in one embodiment.

http://nextdb.net/service/acme.com/sales/RELATE_ROWS?callb ack=callme&id=0&relationshipName=AB&pk1=9342384234523&pk2=32365032 452

Note that pk1 and pk2 in the URL are both SURIDs. The actual primary keys are looked up based on the SURIDs. The URL includes the relationship name, which allows system 100 to lookup the relationship definition, and determines which table pk1 resides in and which table pk2 resides in. Depending on the relationship cardinality, the foreign key whose value is populated might reside in either the row corresponding to SURID pk1 or the row corresponding to SURID pk2.

System 100 provides a convenience function that creates a new row, and links the row to an existing row. The action is guaranteed to be atomic so that if the row creation succeeds, the row is guaranteed to also be linked to the existing row. This is a convenience for developers since it is a common operation in a web based application to create a new entity and link it to a preexisting entity. For example, adding a new blog post to an existing blog.

http://nextdb.net/service/acme.com/sales/INSERT?callback=call me&id=0&relationshipName=T1T2&table=T2&C1=yo&C2=dude&FK=1

The following JavaScript demonstrates the creation of a relationship between tables USER and MESSAGES. Notice that nothing in the code exposes primary keys or foreign key creation to the application:

```
    var conn = new net.nextdb.Connection(“acme.com”,“sales”);
    // get a certain user to whom we will add a new message
    var query = new net.nextdb.Query(“USER”);
    var args={ };
    args[“email”]=“xyz@nextdb.net”;
    args[“pwd”]=“3489f34fh”;
    query.setParameters(args);
    conn.executeQuery(query,
        function(rows,error){
            if(error){
                // handle error
            } else {
                // in the callback from the query we
execute the insert
                var insert = new
net.nextdb.Insert(“MESSAGES”);
                var values = { };
                values.first_name=“John”;
                values.last_name=“Doe”;
                values.message=“some new message”;
                insert.setParameters(values);
                // get a specific SURID
                var key=rows[0].USER.PK;
                // set relationship between the key of
the query results and the insert
                insert.setRelationship(key,
“USER_MESSAGES”);
                conn.executeInsert(insert,
                    function(rowId,error){
                        if(error){
                            // handle error
                        } else {
                            // success
                        }
                    }
                );
            }
        }
    );
```

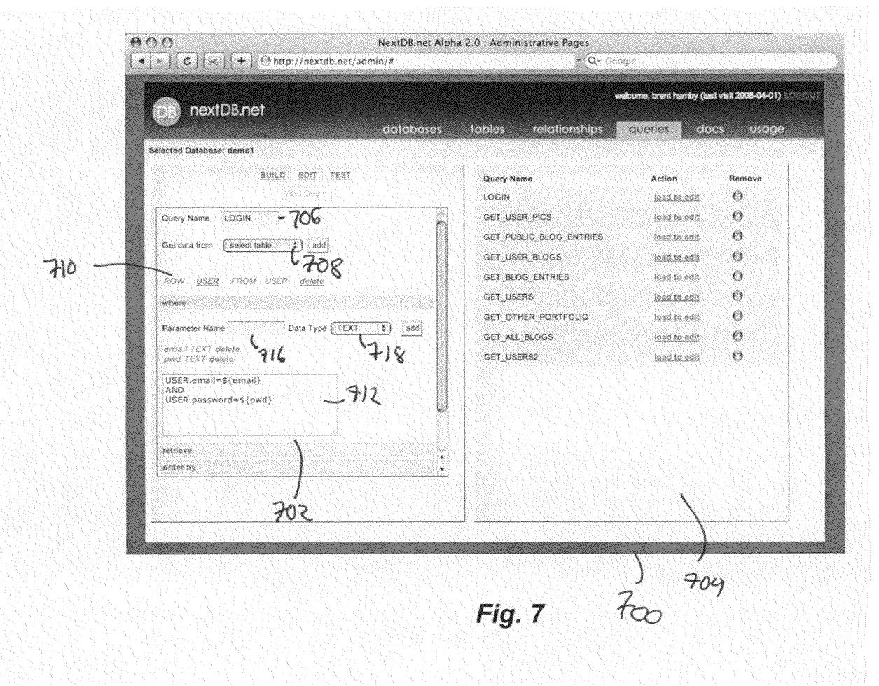

FIG. 7 provides a query management page 700. Query management page 700 provides a region 702 for defining queries, and a region 704 that lists the defined queries. In region 706, application developer 102 names the query. Next, drop down box 708 allows the developer to select the table from which the candidates will be chosen. In one embodiment, query building module 112 automatically generates the query based on input provided by the developer 102. For example, in region 710 the query “ROW USER FROM USER” has been created based upon the selection of the table “USER” from drop down box 708.

The query is further defined by creating a “where” clause, as illustrated in region 712. In one embodiment, developer 102 inputs the where clause directly in free-form into text box 714. Alternatively, by entering a parameter name in field 716 and selecting a data type from drop down box 718, query building module 112 automatically creates the specified syntax, which is displayed in text box 714. For example, in the illustrated case, the developer has specified a parameter name of “email” having data type “TEXT”, and a parameter name of “pwd”, also having type “TEXT”. Using the admin query tool the developer created an empty where clause with parameters. The developer then simply supplies the Boolean expression, for example:

USER.email=${email}

AND

USER.password=${pwd}

Thus, in this example the developer has created a query named LOGIN, which returns each candidate row in the USER table having column values for email and password matching the parameters passed to the query.

FIG J. illustrates a usage monitoring page 800, displayed when tab 312 is selected. Usage monitoring page 800 enables application developer 106 to view usage and performance information about queries, inserts, updates and deletes being performed on the database. In one embodiment, both individual execution times and a moving average are displayed for each of queries, inserts, updates and deletes. In one embodiment, a maintenance button j06 may be selected to force the indexes to be rebuilt according to performance degradation observed through the user interface, as described further below. In one embodiment, indexes are automatically rebuilt based on internal monitoring metrics. In one embodiment, real-time execution information is pushed to the graphs from the hosting server 104, using “comet”, in a manner known to those of skill in the art.

### Query Language

One example of a query supported by system 100 is the following:

```
NAME=LOGIN;
ROW user FROM USER;
WHERE(TEXT email, TEXT pwd){
    user.EMAIL = ${email} AND
    user.PASSWORD = ${pwd}
}
RETRIEVE COUNT(user) into matchCount;
```

The name of the query is mandatory, and is established using the “NAME=<queryname>” syntax. In this case, “LOGIN”. The LOGIN query illustrates how a query can be used to authenticate end-user of an application 118. Application 118 defines the query such that the WHERE clause receives the credentials of an end-user (in this case an e-mail address and a password). The WHERE clause uses the parameters in a Boolean expression to restrict the result set to include only rows with an e-mail address and password matching those provided as query parameters. As a convenience, rather than returning the content of the matching row (or an empty result set in the case of a failure to authenticate), the query uses “RETRIEVE COUNT(user) into matchCount” to simply return the number of rows matched by the query. The application 118 in the client browser will interprets 0 as a failed login, and 1 as a successful login. The query does not specify UPDATE or DELETE change permissions, therefore all rows returned by this query are read-only.

The following is another example of a query in one embodiment:

```
NAME=GET_PUBLIC_BLOG_ENTRIES;
ROW USER_BLOG FROM USER_BLOG;
ROW BLOG_ENTRY FROM BLOG_ENTRY;
ROW USER FROM USER;
USER_BLOG RELATED BLOG_ENTRY VIA BLOG_ENTRIES;
USER RELATED USER_BLOG VIA USER_BLOGS;
WHERE(TEXT email, TEXT name){
    USER_BLOG.name =${name}
    AND
    USER.email=${email}
    AND
    USER_BLOG.public=1
}
RETRIEVE BLOG_ENTRY;
ORDER BY BLOG_ENTRY.created DESCENDING;
```

In the query above, named GET_PUBLIC_BLOG_ENTRIES, the RELATED keyword provides a concise syntax for finding rows that are related to one another. The query illustrates the use of the RELATED keyword to perform a join across three tables. This query will retrieve rows from the BLOG_ENTRIES table that have a value of 1 in their “public” column. However, the RELATED keyword limits the results to rows from BLOG_ENTRIES that are related to a row in the USER_BLOG table. The WHERE clause further restricts the results by specifying that the candidate row in the USER_BLOG table must have a particular value for the “name” column. Finally, the RELATED keyword is used to insure that the candidate USER_BLOG row is related to a row in the USER table that has a particular email address as the value for the “email” column. That is, the query finds all blog entries belonging to a particular blog belonging to a particular user. The query does not specify UPDATE or DELETE change permissions, therefore all rows returned by this query are read-only.

Consider next the following query:

```
NAME=GET_BLOG_ENTRIES;
ROW USER_BLOG FROM USER_BLOG;
ROW BLOG_ENTRY FROM BLOG_ENTRY;
ROW USER FROM USER;
USER_BLOG RELATED BLOG_ENTRY VIA BLOG_ENTRIES;
USER RELATED USER_BLOG VIA USER_BLOGS;
WHERE(TEXT email, TEXT password, TEXT name){
    USER_BLOG.name =${name}
    AND
    USER.email=${email}
    AND
    USER.password=${password}
}
RETRIEVE BLOG_ENTRY;
FOR UPDATE, DELETE;
ORDER BY BLOG_ENTRY.created DESCENDING;
```

This query, named “GET_ALL_BLOG_ENTRIES”, retrieves all the blog entries for a particular blog belonging to a particular user. This query is self-authenticating in that its WHERE clause checks the email address and password of the end-user. Because this query is self-authenticating, the rows can safely be returned using “FOR UPDATE, DELETE;” privileges, which allows the application 118 being executed by the end-user to subsequently update or delete the returned rows. The joins, performed by the RELATED keywords insure that only blog entries “owned” by the particular end user are returned.

As illustrated above, queries can be self-authenticating, which provides read-access control to table rows. The use of SURIDs insure that “you cannot change what you cannot read” and “if you can read it, you might be allowed to write it”. As noted, a SURID is a Secure Unique Result Identifier, and is included in each row returned by a query. In one embodiment, the SURID is a alphanumeric encoding of a 64-bit random number, generated by the server for each row of a result set. In alternative embodiments, the SURID may be longer or shorter. The SURID is of sufficient length that it cannot practically be guessed, and therefore the only way to obtain a SURID is to successfully execute a query. In order to update or delete a row, the request from the application 118 must include the SURID for the row, which allows hosting server 104 to retrieve contextual information about the query that generated the result set, and to determine whether or not the query allows for UPDATE or DELETE. This enables queries that provide “public views” of data, meaning that the query cannot be used to alter the row data; while also enabling queries that provide authenticated “private views” of the same data, permitting authorized parties to delete and update rows.

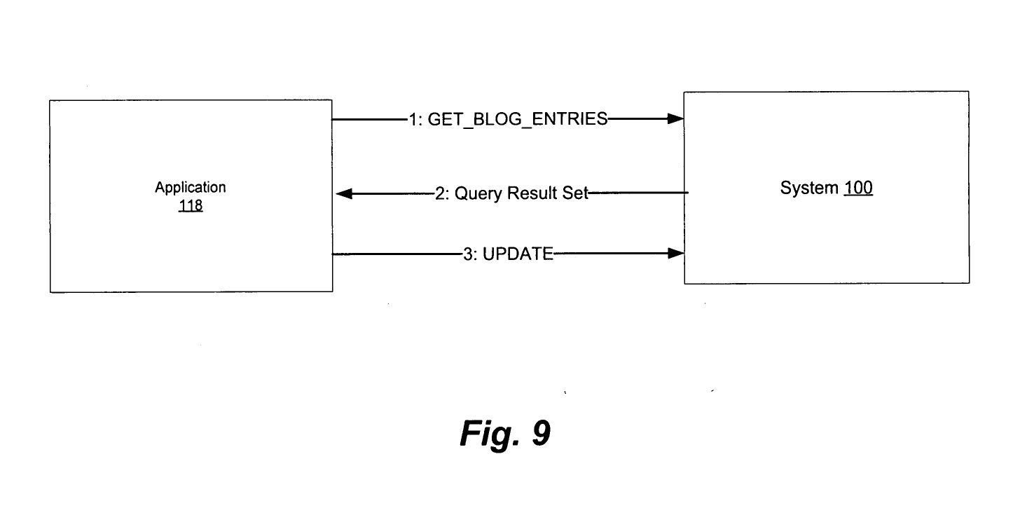

FIG. 9 illustrates the following sequence:

1. Application 118 executes the query named “GET_BLOG_ENTRIES” illustrated above, providing mandatory “email” and “name” parameters.

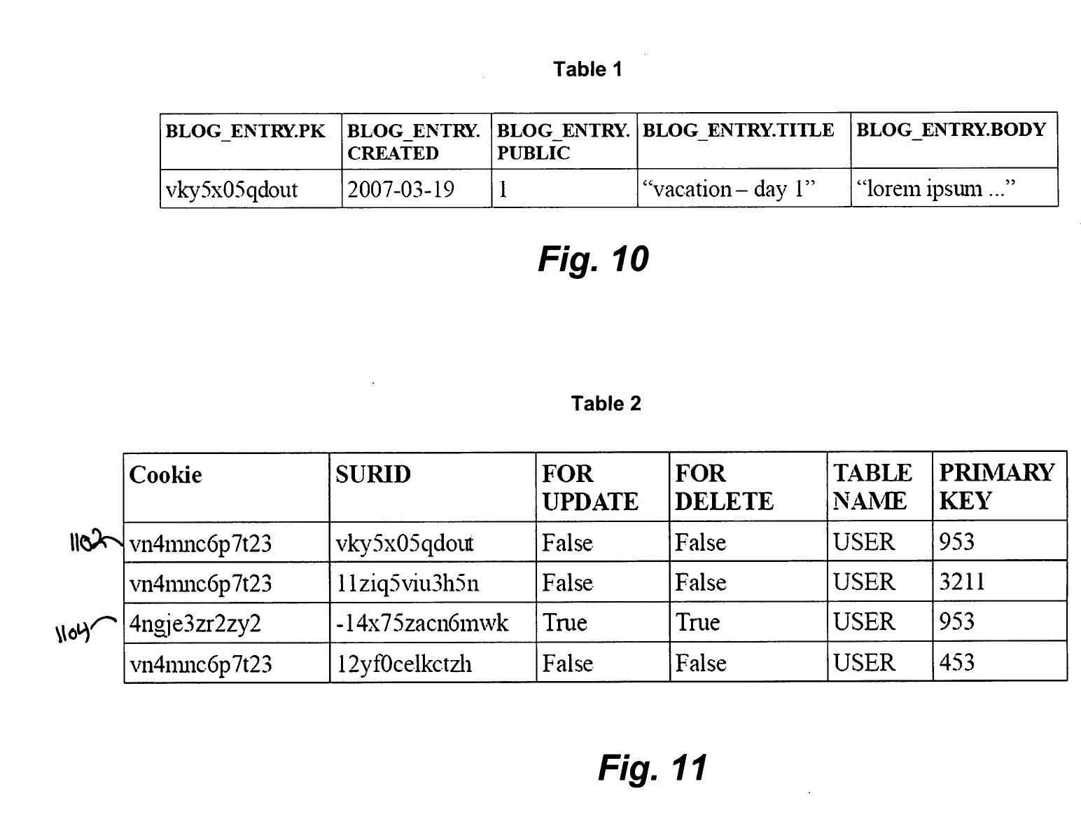

2. System 100, via HTTP server 116, responds with a query result set. Each row of the result set includes a SURID value that is substituted for the actual primary key (PK). FIG. 10 illustrates the result set in one example embodiment.

3. Application 118 executes an UPDATE operation to change the value of the column named “BLOG_ENTRY.TITLE” from “vacation—day 1” to “The first day of the vacation”. The client includes SURID vky5x05qdout in the UPDATE request.

If in step 1 of FIG. 9, the application had executed “GET_PUBLIC_BLOG_ENTIRES”, described above, then step 3 would result in the server returning a SecurityException, indicating a disallowed action, because the “GET_PUBLIC_BLOG_ENTRIES” query does not permit UPDATE or DELETE operations to be performed on the rows it returns.

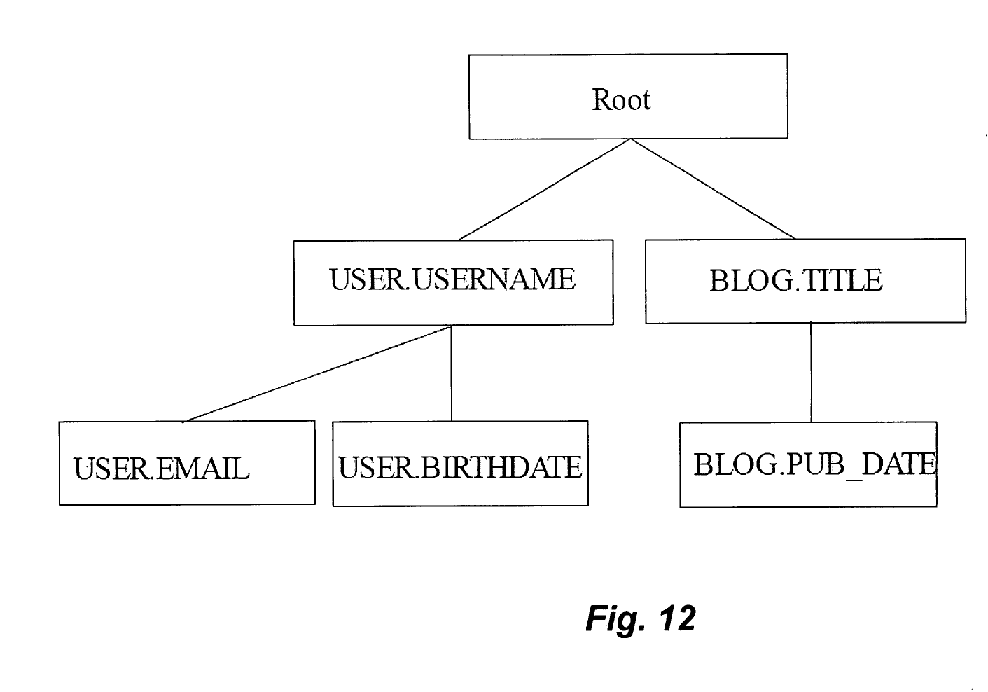

Referring to FIG. 11, table 2 is an example of a change-privileges structure maintained by hosting server 104 for recording the SURIDs that have been returned to client applications. Each SURID is stored in conjunction with the “FOR UPDATE” and “FOR DELETE” privileges of the query that retrieved the row. Notice how PRIMARY KEY 953 occurs in the first row 1102 and third row 1104 of the snapshot. This illustrates how the same row (953) can be returned to the client by two different queries with different levels of access control, thus providing context-sensitive result sets. In row 1102, the SURID is vky5x05qdout and the SURID cannot be used to update or delete the row. In row 1104, the SURID is −14×75zacn6mwk and the SURID can be used to update and delete a row. The cookie column is used to correlate SURIDs with remote clients. It should be recognized that other pointers and values can be stored in the change-privileges structure, such as pointers to the query object itself. It should also be recognized that the change-privileges table can be persisted in a database so as not to require RAM storage.

In one embodiment, another method of generating a SURID is to take a row's primary key, append symbols representing the FOR UPDATE and FOR DELETE permissions of the query that retrieved the row, append an expiration timestamp, and append the name of the table. A nonce may be added as necessary. The resulting string is then encrypted to generate the SURID. Each virtual database 106 encrypts the resulting string with a unique and private encryption key. This method does not require the change-privileges structure since the change privileges are encoded in the encrypted SURID itself. This obviates the need to maintain the change-privileges table, at the expense of a more voluminous SURID which must be returned over the network. In one embodiment, the SURID is not an encrypted value, but instead is generated as described above and then signed by the server using a public key, using MD5 hashing or any other well-known technique.

Although Table 2 (FIG. 11) illustrates tracking of UPDATE and DELETE permissions at the row-level, it is possible to track update and delete permissions at the column level. For example, one could imagine wanting all the columns returned by “GET_BLOG_ENTRIES” to be editable except for the CREATED column, which holds the immutable creation date for the blog entry. System a00 supports this in one embodiment by detecting when individual columns are specified in the RETRIEVE clause, and tracking UPDATE and DELETE permissions in accordance with the subset of a row's columns that the query retrieves, for example as in the query:
RETRIEVE BLOG_ENTRY.PK, BLOG_ENTRY.PUBLIC, BLOG_ENTRY.TITLE, BLOG_ENTRY.BODY FOR UPDATE, DELETE;

### Preventing “Insert Attacks”

As illustrated above, system 100 allows data to be protected from unauthorized reads, updates, and deletes. System 100 also protects tables from unauthorized insertion. In one embodiment, system 100 enables an application developer 102 to make CAPTCHA an optional property of any table. If CAPTCHA is enabled, then data cannot be inserted into the table without providing an accompanying valid CAPTCHA string. This prevents automated processes from inserting spam into the table. The process in one embodiment works as follows:

1. Application 118 obtains a CAPTCHA image from a URL provided by hosting server 104.

2. Hosting server 104 dynamically generates a CAPTCHA image from randomly generated text (the CAPTCHA string), adds the CAPTCHA string to a list of generated CAPTCHA strings, and returns the image bytes to the end user's web browser.

3. When application 118 is ready to insert data into the table, it collects the CAPTCHA string from the end user.

4. Application 118 passes the CAPTCHA string and the data to insert to hosting server 104.

5. Hosting server 104 checks the list of generated CAPTCHA strings to see if the string passed by application 118 is on the list. If the string is in the list, the CAPTCHA is valid, and hosting server 104 proceeds with the insertion and removes the string from the list. If the string is not on the list, hosting server 104 returns a security error to the application.

Applications typically use CAPTCHA to protect the creation of new user accounts from tampering. However, during routine interaction with an application 118, users do not expect to be challenged by CAPTCHA, as doing so would significantly detract from the user experience. Consequently, it is not practical to protect every table in the database with CAPTCHA protection.

Given a first CAPTCHA-protected table, and a related second table that is not CAPTCHA protected, hosting server 104 in one embodiment requires a SURID associated with the first table to be provided with an insertion into the second table. For example, an end user 108 can login to an application by providing his username and password, which are provided as mandatory parameters to a query on the USER table. The query returns the SURID for the row in the CAPTCH-protected table of user accounts to the application. If the application subsequently needs to insert a row into a related table, such as inserting a street-address string into a USER_ADDRESS table, the application must provide the SURID from the user's row in the USER table.

Because only a human can, at present, solve a sufficiently obfuscated CAPTCHA challenge, the method described above prevents “bot” attacks—that is, malicious behavior carried out in an automated fashion by other computer programs. In addition, system 100 implements a solution to prevent a rogue human user of application 118 from registering an account, inserting a single row by providing the CAPTCHA, and then executing a script to insert an unlimited number of rows into a related table.

In one embodiment, HTTP clients (end users) are uniquely identified by their browser's session cookie and individually monitored. Each client is allowed a maximum number of inserts per hour and per day; limits are configurable through the administrative interfaces accessible to application developer 102. If an HTTP client violates a limit, subsequent request are denied until one hour, or one day, has passed. Violations are reported to the application administrator. The particular thresholds and length of access restrictions are variable and may be adjusted according to the preferences of each application developer.

In one embodiment, a table can be completely protected from insertion by designating the table as READ-ONLY using the administrative user interfaces. READ-ONLY tables can still be written to by application developer 102 using the administrative interface to establish the content of the table.

### Automatic Index Creation

Traditional databases require an administrator to create indexes, and rebuild them as necessary to maintain query performance. System 100 provides automatic creation of indexes without any required explicit action on the part of the application developer This is made possible by storing the source for every query defined by the application developer, and because ad-hoc queries are not allowed. This allows the hosting server 104 to analyze all of the queries at once, for a particular virtual database 106, and to create a suitable set of indexes. For example, consider a virtual database that defines four queries, with WHERE clauses as follows:

1. WHERE(TEXT u, TEXT e){USER.USERNAME=${u} AND USER.EMAIL =${e}}

2. WHERE(TEXT u, DATE d){USER.USERNAME=${d}>${d} AND USER.BIRTHDATE}

3. WHERE(TEXT t, TEXT u){BLOG.TITLE=${t} AND USER.USERNAME=${u}}

4. WHERE(TEXT t, TEXT a){BLOG.TITLE=${t} AND USER.USERNAME =${u}AND BLOG.PUBDATE>${d}}

Assuming that composite (multicolumn) indexes can be created but all columns in an index must reside in the same table, then the challenge is to find the unique, minimum, set of indexes required to index all columns accessed by all queries. This can be accomplished by sequentially evaluating each of the WHERE clauses and building a Column Access Tree (CAT). A CAT is an m-way tree in which each node except the root node stores a qualified column name (a qualified column name comprises <TABLENAME>.<COLUMNAME>). The process begins by building an Abstract Syntax Tree (AST) for a WHERE clause. A postorder traversal of the AST is then performed, and column names are inserted into the CAT as they are encountered in the traversal. The postorder traversal respects the order of operations, operator precedence, etc., of operators in the WHERE clause. This allows the CAT to produce indexes which respect the syntax of the query.

Assume the following pseudocode classes:

```
class Root{
    List children;
}
class Column{
    String tableName;
    String columnName;
    List children;
    String getQualfiedName( ){
        return tableName + “.”+columnName;
    }
}
```

The CAT is built by repeating this procedure on each list of postordered columns:

```
var root = new Root( );
var currentNode = root;
var childExists = false;
for (Column c in postorderedColumns) {
    childExists = false;
    if(currentNode.tableName != c.tableName){
        currentNode = root;
    }
for (Column child in currentNode.children) {
    if(child.getQualifiedName( ) == c.getQualifiedName( )){
        currentNode = child; //descend to node with
    matching column name
        childExists = true;
        break;
    }
}
    if(!childExists){
        currentNode.children.add(c);
        currentNode = c;
    }
}
```

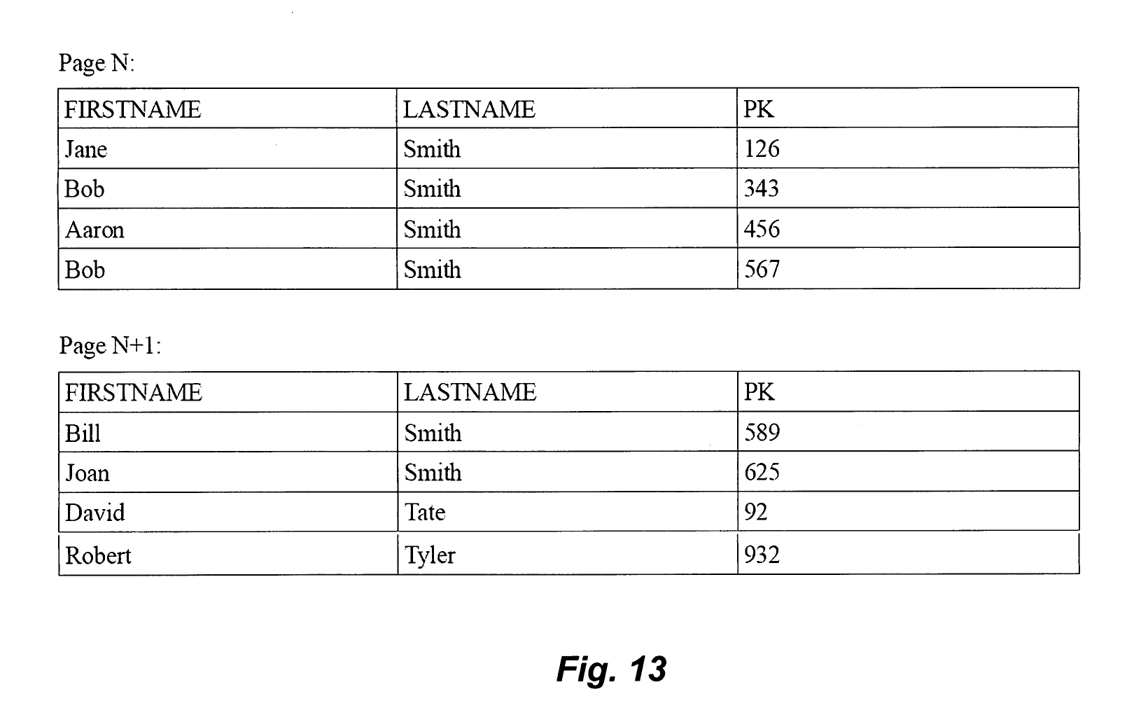

The application of the algorithm above to the four WHERE clause listed earlier produces the CAT shown in FIG. 12. The paths from Root to each of the leaf nodes are:

Root->USER.USERNAME->USER.EMAIL

Root->USER.USERNAME ->USER.BIRTHDATE

Root->BLOG.TITLE->BLOG.PUB_DATE

Each of the paths is used to generate an index:

“CREATE INDEX NEXTDB_USER_USERNAME_USER_EMAIL ON USER(USERNAME, EMAIL)”

“CREATE INDEX NEXTDB_USER_USERNAME_USER_BIRTHDATE ON USER(USERNAME, BIRTHDATE)”

“CREATE INDEX NEXTDB_BLOG_TITLE_BLOG_PUB_DATE ON BLOG(TITLE, PUB_DATE)”

### Handling of HTTP GET Requests

System 100 uses both RPC style commands, invoked via HTTP GET requests, and on REST-style URLs. Examples of HTTP GET URL formats that system 100 uses are:

1. Service URL's:

http://nextdb.net/nextdb/service/<account>/<database>/<servic e>?<callback>&<requestld>[&<p>]*

In the RPC URL above, [&<p>]* means “zero or more service-specific URL query parameters”.

2. File Serving URL's:

http://nextdb.net/files/<account>/<database>/<table>/<column>/<permanent-ID>[/<dims>/<rot>]

In the REST-style URL above, [/<dims>/<rot>] means “an option dimension and rotation for image files”. For example, “. . . /512/90” will scale the image so that its longest dimension is 512 pixels, and so that is rotated 90 degrees.

Each application developer 102 has an account with a unique name of his choosing. Virtualization engine 110 maps account names into a directory on the hosting server 104 whose name matches the account name. That directory contains the physical database files for a single physical database. Application developers are provided with the metaphor of a “database”, but in fact, what the application developer perceives as a database is actually a “schema” in the parlance of the RDBMS whose physical database files reside in the account directory.

The use of a separate physical database files, stored in a unique directory, for each account, has many system administration benefits. For example, it is easy to keep track of disk usage on a per-account basis using standard Unix utilities such as “du”. It is also easy to maintain backups and move physical databases between servers, one account at a time, when each account occupies one directory. System 100 does, however, support an embodiment in which multiple accounts can share a single physical database and schema. In this embodiment, a table naming convention is used to identify the account and virtual database 106 in which a particular table resides.

In one embodiment, for each account, virtualization server 110 maintains an in-memory data structure called an ORMDictionary (Objectrelational mapping dictionary). The ORMDictionary provides many different forms of information that are needed by the system at runtime. The ORMDictionary for a particular account is initialized the first time an RPC URL is accessed for a given account. Subsequently, changes to the structure of a database's tables, relationships, or queries, are persisted to the database, and then updated into the in-memory ORMDictionary. The ORMDictionary contains three primary structures:

1. Object-relational mapping—one per table, and not limited to the following:
a. real qualified table name
b. column names
c. column data types (and mappings between native data types and SQL data types)
d. column meta data (for example, if a column is a “helper column” maintained by system 100)
e. whether CAPTCHA is required for a given table

2. Relationship definitions:
a. participant table names
b. cardinality of relationship (i.e. “one to many” or “one to one”)

3. Query definitions:
a. query source program

When a service URL is invoked, the ORMDictionary will be loaded into memory if it is not already active. A security check is then performed to insure at least the following:

1. For system-administrative level services, that the service has been requested by the system administrator.

2. For account-level services (such as creating a database), that the service has been requested by the authenticated account owner.

3. For database-level services, such as creating a new table, insuring that:
a. the service has been requested by the authenticated account owner
b. insuring that the <database> named in the RPC request belongs to the authenticated account owner.

Following successful application of the security check, a singleton instance of the particular service is obtained, and the service is invoked by passing the RPC URL to the service. The service returns a JSON object to the service dispatcher, and is wrapped in a JS callback by the dispatcher. Some services implement logging interfaces, so that after they return a response to the dispatcher, the execution time and request parameters are recorded in a buffer that is made available to the account holder in the form of graphs and charts.

### Enforced Result Set Paging

Result set paging is a feature of system 100. All results sets in system 100 are paged. That is to say, the client must select a portion of the logical result set for retrieval. Retrieval of the entire result set in one query is not allowed, unless the number of results is less than or equal to the page size. Enforcement of the paging policy insures that system 100 is not subject to denial of service by a malicious application that retrieves a vast quantity of rows. The paging support operates in two modes. The first mode is one in which the expression that is executed by the query does not include an ORDER BY keyword. In this case, the application 108 may supply the pageSize argument, which defaults in one embodiment to 100 if not provided, and has a maximum size of 1000. In addition, the application may provide a startAfterPK. The startAfterPK is a SURID which identifies the last record of the previous page retrieved by the application. If the startAfterPK is not provided by the application, the first page of query results is returned.

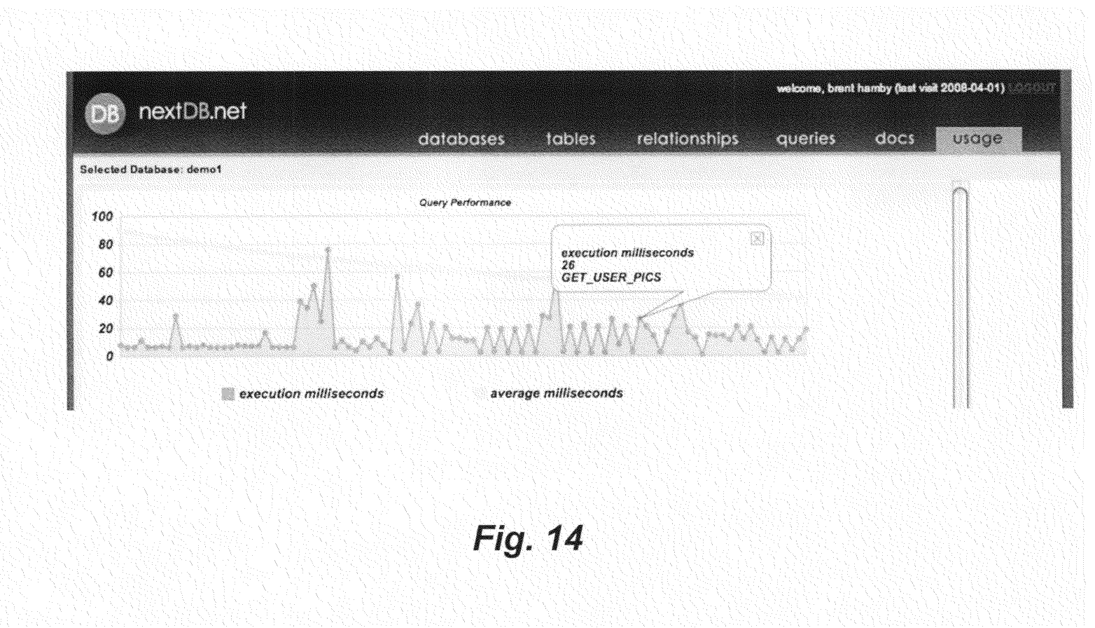

A second mode in which paging can be used is to support paging through results when returned from a query that used the ORDERY BY <candidate>.<column> syntax. In this mode, the query results are ordered first on the requested column, and second on the PK column. For this reason a startAfterValue argument must be passed in addition to startAfterPK, in order to preserve consistent page ordering. For example consider ORDERY BY USER.LASTNAME. FIG. 13 illustrates the database content of two consecutive pages when the pageSize=4.

In order to retrieve the page labeled “Page N+1”, the application would pass startAfterPK=<SURID> and startAfterValue=Smith, where <SURID> would be the SURID corresponding to PK 567.

### Dynamic Shaping of Result ISON

Traditional object-relational mapping systems require the definition of a class in a programming language. Fields of objects defined by the class are mapped into columns of the database. The query language implemented by system 100 allows JSON Objects to be dynamically composed in the query response, without a corresponding class definition. This provides the application program with an object whose fields are populated from the database.

In the “posts” query (below) it is not necessary to return the blogger candidate in order to fulfill the objective of the query, which is to retrieve all the blog post made by a particular blogger. If more than one post candidate meets the criteria specified in the WHERE clause, the blogger candidate row, to which the post candidate rows are related, would be redundantly repeated in each element of the result array. The query can be refined to avoid this redundancy and only return rows from the BLOGGER_POSTS table. This is accomplished on line 11 (below) by using the RETRIEVE keyword. When the RETRIEVE keyword is used, only ROW candidates referenced in the RETRIEVE clause will appear in the resulting JSON Array. The absence of the blogger candidate in the RETRIEVE clause causes it to be committed from the result set.

1. /*******************************************************
2. ***Use RETRIEVE clause to return only the post candidate
3. ********************************************************/
4. NAME=posts;
5. ROW blogger FROM BLOGGER;
6. ROW post FROM BLOG_POSTS;
7. blogger RELATED post VIA bloggerPosts;
8. WHERE(TEXT name){
9. blogger.bloggerName = ${name}
10.}
11.RETRIEVE post;

By retrieving only the ‘post’ candidates, we reshape the results Array to retrieve a more focused JSON response that contains only the post candidate.

1. [
2. {
3. post:{
4. PK:2352762368,
5. title:“vacation - day 1”,
6. content:“lorem ipsum ...”,
7. date:“10-13-2007 16:43:54:323 GMT”
8. }
9. }
10.]

Continuing with the example of retrieving blog posts, the response can be changes to return only the title of the post. On line 11 (below), the RETRIEVE specification is altered to fetch only the title column of the post candidate.

1. /*******************************************************
2. ***Use RETRIEVE clause to return only the post title
3. ********************************************************/
4. NAME=posts;
5. ROW blogger FROM BLOGGER;
6. ROW post FROM BLOG_POSTS;
7. blogger RELATED post VIA bloggerPosts;
8. WHERE(TEXT name){
9. blogger.bloggerName = ${name}
10.}
11.RETRIEVE post.title;

The following JSON is returned:

1. [
2. {post:{title:“vacation - day 1”}}
3. ]

The title can be accessed from a JavaScript program as result[0].post.title. We can further reshape the JSON response to make it even easier to access the title column, by using the ‘into’ keyword. In the following NextQuery program in which we alter the RETRIEVE clause to return only the primitive column value into a field named ‘caption’:

1. /*******************************************************
2. *** Use RETRIEVE clause to return only the column named
3. *** ‘title’. Use the ‘into’ keyword to return the title
4. *** column as a primitive field named ‘caption’
5. ********************************************************/
6. NAME=posts;
7. ROW blogger FROM BLOGGER;
8. ROW post FROM BLOG_POSTS;
9. blogger RELATED post VIA bloggerPosts;
10.WHERE(TEXT name){
11. blogger.bloggerName = ${name}
12.}
13.RETRIEVE post.title into caption;

The following JSON is returned in which the title column can now be accessed as result[0].caption

1. [
2. {caption:“vacation - day 1”}
3. ]

The following JSON listing shows the primitive field, ‘count’ which will contain the count of the number of posts made by a given blogger.

1. [
2. {count:24}

### Mixing Objects Together on the Fly

The ‘into’ keyword can be used to mix together different candidates and their constituent columns, creating completely new object structures which are composites. On line 8 of listing 13, the entire ‘post’ ROW candidate is mixed together with the ‘bloggerName’ column of the ‘blogger’ candidate to create an entirely new Object structure named ‘thePost’.

```
3.
    1. /*****************************************************
    2. *** Use RETRIEVE clause to mix together fields of the
    3. *** post and the blogger candidates into a new hybrid
    4. *** Object placed in a field nmed ‘thePost’
    5. *****************************************************
      */
    6. NAME=posts;
    7. ROW blogger FROM BLOGGER;
    8. ROW post FROM BLOG_POSTS;
    9. blogger RELATED post VIA bloggerPosts;
    10.WHERE(TEXT name){
    11.  blogger.bloggerName = ${name}
    12.}
    13.RETRIEVE post into thePost, blogger.bloggerName into
      thePost.author
      ;
```

The following listing shows the JSON representation of a query results Array containing a single instance of the newly defined Object, ‘thePost’.

14.[
15. {
16. thePost:{
17. PK:2352762368,
18. title:“vacation - day 1”,
19. content:“lorem ipsum ...”,
20. date:“10-13-2007 16:43:54:323 GMT”,
21. author:“swampy”
22. }
23. }
24.]

The ‘into’ keyword can also be used in conjunction with aggregates. An aggregate is a value that, as the name implies, aggregates data from across many columns. For example, the average value of an integer-valued column is computed by adding together (aggregating) all the columns, then dividing by the number of columns. The RETRIEVE keyword can be used to retrieve aggregate information such as COUNT, AVG, MIN, MAX and SUM.

25./*******************************************************
26.*** RETRIEVE COUNT into a primitive field, ‘count’
27.*******************************************************
*/
28.NAME=posts;
29.ROW blogger FROM BLOGGER;
30.ROW post FROM BLOG_POSTS;
31.blogger RELATED post VIA bloggerPosts;
32.WHERE(TEXT name){
33. blogger.bloggerName = ${name}
34.}
35.RETRIEVE COUNT(post) into count;

The following JSON listing shows the primitive field, ‘count’ which will contain the count of the number of posts made by a given blogger.

1. [
2. {count:24}
3. ]

### Query Monitoring and Jailing

System 100 is capable of serving many applications 118 at once. Therefore, no single application should be allowed to consume more than some allocated share of resources. In any database, poorly designed queries are prone to consuming excessive I/O and CPU resources. Automatic index creation reduces the likelihood of table scans, but cannot eliminate the possibility that a query that joins many tables could exhibit poor performance. It is also difficult to tell, at the time a query is created, if it eventually will slow down as the tables increase in size. System 100 implements a real-time monitoring process designed to detect queries that perform poorly, and allow the application developer to intervene and correct the problem. If the problem is not corrected, system 100 will escalate a series of actions, ultimately culminating in “jailing” a query, which means refusing to execute the query.

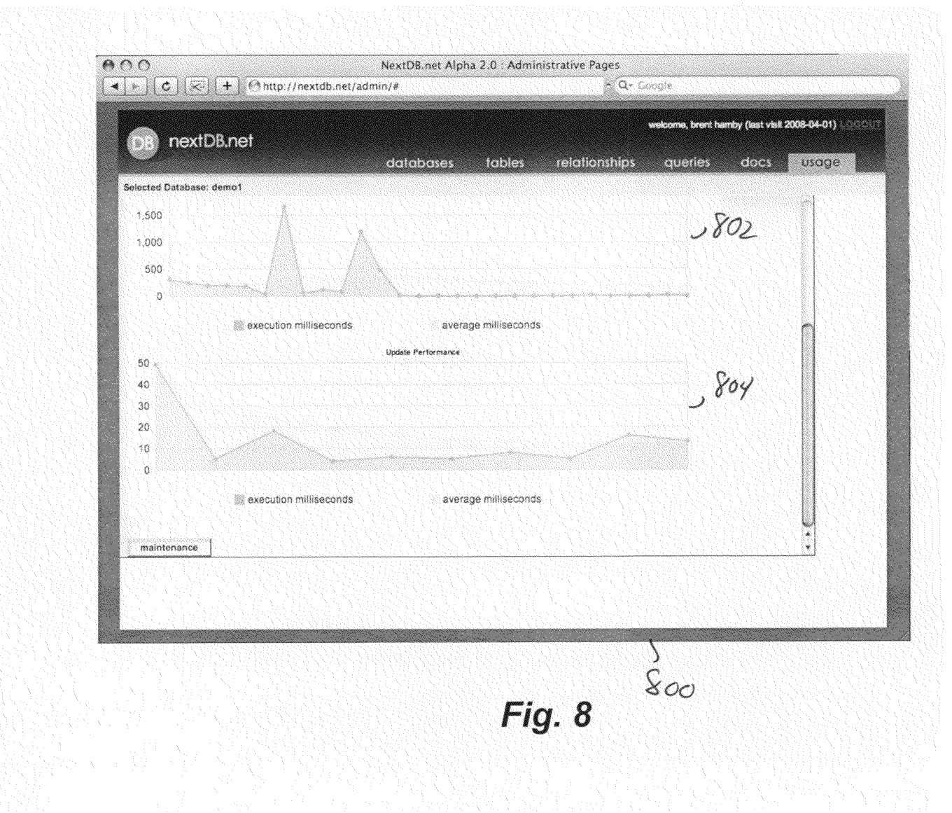

As illustrated above with respect to FIG. 8, system 100 provides a web-based graphical user interface including an interactive performance charts feature. In one embodiment, the performance charts are line graphs and there is one chart for each of queries, updates, deletes, and inserts. FIG. 8 illustrates two of these graphs—inserts 802, and updates 804, and FIG. 14 provides an additional view. In each graph, the Y-axis displays execution time, in milliseconds. The X-axis displays the last 100 invocations of the action. Each chart displays the service time for each invocation, as well as the moving average of service times for the last I 00 invocations. The user can place his mouse pointer on any point in the graph and the graph will display the exact service time. Each graph is correlated with a tabular display of all contextually-relevant information for the action performed. As the user moves his mouse-pointer around the graph, the correlated information is highlighted. For queries, the correlated information includes all the name of the query, and all the query parameters. This is useful in debugging the source of performance problems. The moving average line-graph allows the user to determine if a “performance spike” is an isolated occurrence or part of a trend toward decreasing performance.

Internally system 100 maintains a moving average execution time for each query that an application defines. After a “warmup period”, which in one embodiment is the first execution of a query, and which typically takes much longer than subsequent executions because the database is compiling query execution plans and performing other one-time activities, system 100 begins monitoring the moving averages. If the moving average exceeds a warning threshold, the application developer 102 for that application will be notified, for example by email. If the moving average subsequently exceeds a second threshold, the query will be “jailed”. When a query is jailed, system 100 simply refuses to execute the query until the query has been altered to improve its execution time. Jailed queries are called-out in the administrative user interface. To remove the query from “jail” and return it to a normally executing state, the application developer initiates a “get out of jail” test sequence, using the administrative interface, which allows the system to verify that the query's moving average execution time is below the jail's threshold.

### Queuing, Quality of Service, and Client-Side Backoff

In one embodiment, hosting server 104 does not directly execute a query, insert, update, or delete upon receipt of the operation by HTTP server 116. Instead, the query is placed into a queue. System 100 in one embodiment implements preemptive priority queuing to provide lower latencies for higher priority jobs. This allows system 100 to offer various levels of quality of services (QOS). When the average waiting time of queries in the queue reaches a predetermined threshold, the hosting server 104 may temporarily deny entry to the queue. When entry to the queue is denied, the JavaScript client API of application 118 will perform a “binary backoff” operation, which is to say it waits a predetermined amount of time, and then resubmits the operation for execution. If the queue is still closed, the JavaScript API will double the waiting period, wait, and then resubmit. This process continues until either the operation is accepted into the queue, or a maximum wait time is exceeded, at which point the JavaScript API will return an error to the application. The application program can receive asynchronous notifications from the JavaScript API regarding the progress of execution and the state of any “clientside backoff” that may be in progress. This allows the application to present the end user with appropriate messages and progress indicators, including the opportunity to cancel an operation that is queued or has backed off, during times of congestion. The participation of the JavaScript API in the QOS process prevents the server from being overwhelmed during times of peak activity.

### Binary Columns as RESTful Resources

As described above, REST-style URLs are generated for any column whose type is LONGBINARY. When a LONGBINARY column is created, three additional read-only columns are created to store the meta-data describing the binary data:

<COLUMN_NAME>_LENGTH reports the number of bytes in the binary;

<COLUMN_NAME>_CONTENT_TYPE reports the content type of the binary, for example “image/gif”;

<COLUMN_NAME>_FID contains a unique file identifier. This is a long unique number that is used to create permalinks to the file.

Many web applications need to make files accessible in the form of hyperlinks on an HTML page. These links work best if they are permanent and never go stale. A permanent link can be emailed to friends and can even be pasted into blog entries. System 100 supports “permalinks” (permanent links) for LONGBINARY columns. In one embodiment, system 100 uses the following format:

http://nextdb.net/files/<account>/<database>/<table>/<column >/<permanent-ID>

For example, the following could be a permalink to a picture of a T-SHIRT in the IMAGE column of a TSHIRTS table, in a database named “catalog” in an account named “kungfu.net”.

http://nextdb.net/files/kungfu.net/catalog/TSHIRTS/IMAGE/36 48583

When the binary data in the LONGBINARY column is an image, the REST-style URL above may be augmented with a trailing dimension “path” and a trailing rotation “path”. For example, in order to retrieve a thumbnail image of a t-shirt, the URL above can be modified as follows:

http://nextdb.net/files/kungfu.net/catalog/TSHIRTS/IMAGE/36 4927364548583/256/90

The effect of the “256” is to scale the original image so that its largest dimension is 256 pixels. The “90” causes the image to be rotated 90 degrees.

Reference in the specification to “one embodiment” or to “an embodiment” means that a particular feature, structure, or characteristic described in connection with the embodiments is included in at least one embodiment of the invention. The appearances of the phrase “in one embodiment” or “a preferred embodiment” in various places in the specification are not necessarily all referring to the same embodiment.

Some portions of the above are presented in terms of methods and symbolic representations of operations on data bits within a computer memory. These descriptions and representations are the means used by those skilled in the art to most effectively convey the substance of their work to others skilled in the art. A method is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations of physical quantities as modules or code devices, without loss of generality.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention can be embodied in software, firmware or hardware, and when embodied in software, can be downloaded to reside on and be operated from different platforms used by a variety of operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein, and any references below to specific languages are provided for disclosure of enablement and best mode of the present invention.

While the invention has been particularly shown and described with reference to a preferred embodiment and several alternate embodiments, it will be understood by persons skilled in the relevant art that various changes in form and details can be made therein without departing from the spirit and scope of the invention.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

We claim:

1. A method for providing a hosted web database, the method comprising:
creating a virtual database, the virtual database associated with an account holder;
receiving a query from an application over a network, the query including authentication credentials and query parameters, the application executed in a client browser;
determining a query result set, the query result set including at least one candidate in the virtual database satisfying the query parameters and the authentication credentials; and
returning at least a portion of the query result set.

2. A system for providing a hosted web database, the system comprising:
a virtualization engine, adapted to create a virtual database on at least one database server;
a virtual database;
an HTTP server, adapted to receive a query from an application over a network, the query including authentication credentials and query parameters, the application executed in a client browser;
a hosting server, coupled to the virtual database and the HTTP server, and adapted to determine a query result set, the query result set including at least one candidate in the virtual database satisfying the query parameters and the authentication credentials, and to return at least a portion of the result set.
